(19) United States
(12) Patent Application Publication
(10) Pub. No.: US 2024/0126896 A1
(43) Pub. Date: Apr. 18, 2024

(54) SYSTEM AND METHOD FOR ENCRYPTING MACHINE LEARNING MODELS

(71) Applicant: Technology Innovation Institute - Sole Proprietorship LLC, Masdar City (AE)

(72) Inventors: Ibrahim M. Elfadel, Abu Dhabi (AE); Rupesh Karn, Abu Dhabi (AE); Kashif Nawaz, Abu Dhabi (AE)

(73) Assignee: Technology Innovation Institute - Sole Proprietorship LLC, Masdar City (AE)

(21) Appl. No.: 18/479,894

(22) Filed: Oct. 3, 2023

Related U.S. Application Data
(60) Provisional application No. 63/378,190, filed on Oct. 3, 2022.

(51) Int. Cl. G06F 21/60; H04L 9/00; H04L 9/14; G06N 20/00

(52) U.S. Cl. CPC G06F 21/602; H04L 9/008; H04L 9/14; G06N 20/00

(57) ABSTRACT

A server system that includes a host device initiates an encrypted decision tree model executing on an accelerator coupled with the host device. The encrypted decision tree model encrypted uses an agreed upon encryption schema between the host device and a user device accessing the encrypted decision tree model. The host device receives an input, from the user device, to be evaluated using the encrypted decision tree model. The input is encrypted using the agreed upon encryption schema. The host device using the encrypted decision tree model evaluates the input from the user device without decrypting the input. The accelerator using the encrypted decision tree model generates an encrypted output based on the evaluating. The accelerator device provides the encrypted output to the user device.

### CROSS-REFERENCE TO RELATED APPLICATIONS

This application claims priority to U.S. Provisional Application Serial No. 63/378,190, filed Oct. 3, 2022, which is hereby incorporated by reference in its entirety.

### FIELD OF DISCLOSURE

The present disclosure generally relates to a system and method of encrypting machine learning models.

### BACKGROUND

In many fields of research and industry, machine learning (ML) and artificial intelligence (AI) are becoming dominant problem-solving tools. For example, the medical industry provides automatic medical evaluations and risk profiles for various diseases by analyzing a user's DNA profile through AI. In finance, there are automated systems and services that decide loan grants based on information provided by the user.

### SUMMARY

In some embodiments, a server system that includes a host device initiates an encrypted decision tree model executing on an accelerator coupled with the host device. The encrypted decision tree model encrypted uses an agreed upon encryption schema between the host device and a user device accessing the encrypted decision tree model. The host device receives an input, from the user device, to be evaluated using the encrypted decision tree model. The input is encrypted using the agreed upon encryption schema. The host device using the encrypted decision tree model evaluates the input from the user device without decrypting the input. The accelerator using the encrypted decision tree model generates an encrypted output based on the evaluating. The accelerator device provides the encrypted output to the user device.

In some embodiments, a non-transitory computer readable medium is disclosed herein. The non-transitory computer readable medium includes one or more sequences of instructions, which, when executed by one or more processors, causes a server system to perform operations. The operations include initiating, by the server system including a host device, an encrypted decision tree model executing on an accelerator coupled with the host device. The encrypted decision tree model encrypted using an agreed upon encryption schema between the host device and a user device accessing the encrypted decision tree model. The operations further include receiving, by the host, an input, from the user device, to be evaluated using the encrypted decision tree model. The input is encrypted using the agreed upon encryption schema. The operations further include evaluating, by the host device using the encrypted decision tree model, the input from the user device without decrypting the input. The operations further include generating, by the host device using the encrypted decision tree model, an encrypted output based on the evaluating. The operations further include providing, by the host device, the encrypted output to the user device.

In some embodiments, a system is disclosed herein. The system includes a processor and a memory. The processor is in communication with an accelerator that includes an encrypted decision tree model executing thereon. The memory has programming instruction stored thereon, which, when executed by the processor, causes the system to perform operations. The operations include initiating the encrypted decision tree model executing on the accelerator. The encrypted decision tree model is encrypted using an agreed upon encryption schema between the system and a user device accessing the encrypted decision tree model. The operations further include receiving an input, from the user device, to be evaluated using the encrypted decision tree model. The input is encrypted using the agreed upon encryption schema. The operations further include evaluating, using the encrypted decision tree model, the input from the user device without decrypting the input/ The operations further include generating, using the encrypted decision tree model, an encrypted output based on the evaluating. The operations further include providing the encrypted output to the user device.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating computing system, according to example embodiments.

FIG. 2 is a block diagram illustrating a computing environment, according to example embodiments.

FIG. 3 is a block diagram illustrating an example decision tree model, according to example embodiments.

FIG. 4 is a block diagram illustrating an example decision tree model, according to example embodiments.

FIG. 5 is a block diagram illustrating an example combinational circuit design, according to example embodiments.

FIG. 6 is a block diagram illustrating an example sequential circuit design, according to example embodiments.

FIG. 7 is a flow diagram illustrating a method of evaluating a data input using an encrypted machine learning model, according to example embodiments.

FIG. 8 is a block diagram illustrating computing system, according to example embodiments.

FIG. 9 is a block diagram illustrating a computing environment, according to example embodiments.

FIG. 10 is a flow diagram illustrating a method of evaluating a data input using an encrypted machine learning model, according to example embodiments.

FIG. 11 illustrates an example system bus architecture of computing system, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Many artificial intelligence services entail the exposure of sensitive data. Such data is extremely vulnerable to a man-in-the-middle attack, in which an unauthorized individual gains access and uses the data for illicit purposes. On the service end, the artificial intelligence model's intellectual property should be protected. Training an artificial intelligence model takes hours or days, and once trained, it is made available in the cloud, where users may access it via an API. An AI service provider charges a considerable amount of money to cover the training expenditures and generate revenue to sustain the business. Providing the trained model available to the public without encryption may breach the privacy of the training data and make it susceptible to model inversion attacks. A bank, for example, that employs a decision tree model for credit evaluation in order to provide loans to its clients may not wish to divulge any information about the model. Traversing the nodes of the decision tree would reveal the thresholds utilized over each attribute of the customer's data for loan issuance decisions. The man-in-the-middle attacker can successfully tweak her data to avoid such criteria and win the loan decision. Furthermore, to accelerate inference processing, these models are typically run on hardware accelerators using programmable ASIC, configurable, or embedded technologies. Such technologies are of course easier to attack in an edge-computing context than in a cloud- computing one. In the former case, only computationally friendly or lightweight security measures are feasible. If a confidential inference solution is to be implemented end-to-end, it is the edge computing context that should receive particular attention.

One or more embodiments disclosed herein address the issue of confidential inference in edge computing, and offer a technique for evaluating an encrypted AI model on encrypted data at the edge accelerator in a computationally efficient manner. For example, one or more techniques disclosed herein utilize an FPGA as the accelerator platform and a decision tree as the supervised machine learning model.

Consider a scenario in which an accelerator (Alice) holds an encrypted model that was previously trained on plain datasets. A client (Bob) then intends to use that model to get the inference result by supplying encrypted data. The goal of the confidential inference is to obtain the inference result while retaining the privacy of both the machine learning model and the client data. After inference, the machine learning result is sent to the client only in encrypted form.

In some embodiments, one or more techniques disclosed herein may use a computation mechanism termed “fully homomorphic encryption” to achieve this functionality. In some embodiments, one or more techniques disclosed herein may use order-preserving cryptography techniques to achieve this functionality.

Embodiments disclosed herein may also provide possible accelerator implementations using purely combinational circuits. Earlier work on accelerator design of decision trees includes light-weight training for large datasets. For decision tree inference, an accelerator design may be geared for drone pilot identification. Early work on confidential decision tree inference include cloud-based implementations are used due to encryption complexity. One or more techniques disclosed herein may leverage the hardware acceleration of such confidential decision inference so as to make it accessible to edge devices.

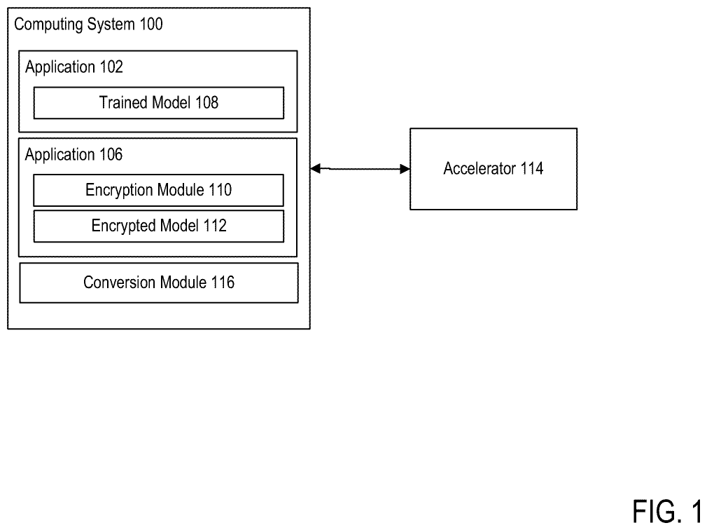

FIG. 1 is a block diagram illustrating computing system 100, according to example embodiments. As shown, computing system 100 may include an application 102. Application 102 may allow a user of computing system 100 to train a machine learning model for a task. In some embodiments, machine learning model may be representative of a decision tree based model. In some embodiments, machine learning model may be representative of a random forest model, which can be considered a multiplicity of decision tree models. At the end of training, computing system 100 may include a trained machine learning model (hereinafter “trained model 108”).

Assume the dataset [symbol] =[ [symbol] ₓ, [symbol] _{y}] where [symbol] ₓ denotes the training samples and [symbol] _{y} denotes the class labels. In classification, the label of a leaf node is one of the [symbol] _{y} labels. If L is the number of features, let [symbol] ₓ. 1≤i≤L, denotes the i^{th} feature. The number of unique values in [symbol] _{y} represents the number of class labels, denoted l. DT training is made of two basic steps: Induction and Pruning. Induction is the process of generating nodes, selecting node features, and evaluating nodal information gains to assign decision rules at each internal node and labels at each terminal node. One side effect of induction is the possible generation of duplicate nodes. Pruning is then responsible for eliminating duplicates and preventing over-fitting. Assume now the trained DT model has N internal nodes: I₁, I₂, . . . , I_{N}, and n terminal or leaf nodes: T₁, T₂, . . . , Tₙ. Then the decision rule at Iₖ is embodied in threshold value Λₖ. The data feature [symbol] ₓ_{ₖ} at node Iₖ and the threshold Λₖ define the inequality used in the decision rule of node Iₖ, which is expressed as:

[symbol]

ₓ_{ₖ} <Λₖ or [symbol] ₓ_{ₖ} ≥Λₖ (1)

At the end of the training, one of the class labels of the dataset b ∈ [0, l−] is assigned to each terminal node Tᵢ.

As shown, computing system 100 may further include application 106. Application 106 may be configured to encrypt trained machine learning model 108 using encryption module 110. Encryption module 110 may be configured to convert trained machine learning model 108 into a secure representation that can be used for inference without disclosing any information about the learned model parameters (e.g., the feature and the threshold involved in a given decision rule). The secure representation may then receive inference data in encrypted form and deliver the correct inference result also in encrypted form.

In some embodiments, encryption module 110 may be configured to use a fully homomorphic encryption algorithm to encrypt trained machine learning model 108. In some embodiments, the fully homomorphic encryption algorithm may be based on the Craig Gentry algorithm. For a message bit m, encryption module 110 may utilize the Craig Gentry algorithm to encrypt message bit m as follows:
a) Select a random positive integer q as public key.
b) Select a random positive odd integer p as private key.
c) To strengthen the encryption, select a random integer r as a noise parameter such that |r|<p/2.
d) Encrypt the message bit m as c=p×q+2×r+m
e) Perform homomorphic addition or multiplication as required. For example,

C_{add}=c₁±c₂ or Cₘᵤₗ=c₁×c₂.
f) Decrypt the homomorphic computations. For example:

m₁±m₂=(C_{add} mod p)mod 2; or m₁×m₂=(Cₘᵤₗ mod p) mod 2

In the case of an μ-bit binary message μ and under the assumption that r=0, encryption module 110 may encrypt each bit independently. The ciphertext of the 0 bit is 0+p×q and that of the 1 bit is 1+p×q. The number of bits (or bit width b_{w}) needed to represent the cipher of either bit 0 or 1 is b_{w}=max([ln₂(0+pq)+1], [ln₂(1+pq)]+1). The bit width of the cipher to represent μ bits of plain text is μ×b_{w} bits.

To improve upon the Craig Gentry algorithm by allowing the encryption algorithm to accept any numeric value M, encryption module 110 may utilize a modified version of the Craig Gentry algorithm with the following modifications:
1) In step (a), select an odd integer as a public key q.
2) In step (b), select another odd integer as a private key p such that p and q are relatively prime.
3) The multiplication p×q must be greater than the message m.
4) In step (c), set r=0, and compute the ciphertext c=p×q+m.
5) In step, (f), decrypt as follows:
m₁±m₂=C_{add} mod p or m₁×m₂=Cₘᵤₗ mod p.

To encrypt the decision tree, encryption module 110 may encrypt the computations at the internal nodes. For example, after training, each internal node makes a “greater-than” or “less-than” comparison between the assigned threshold and the value of the data feature, which can be re-written as:

[symbol]

ₓ_{ₖ}−Λₖ<0 or [symbol] ₓ_{ₖ}−Λₖ≥0 (2)

Let E be the homomorphic encryption operator, then the encrypted versions of the above inequalities are written as:

E( [symbol] ₓ_{ₖ})−E(Λₖ)<0 or E( [symbol] ₓ_{ₖ})−E(Λₖ)≥0 (3)

Note that in Eq. (3), only the additive feature of homomorphic encryption is used, i.e., [symbol] ₓ_{ₖ}−Λₖ=Dₚ(E( [symbol] ₓ_{ₖ})−E(Λₖ)), where Dₚ is the decryption operator using the p private key. Along with encrypting the data features [symbol] ₓ_{ₖ} and thresholds Λₖ, the leaf node labels are also encrypted. The inferred class label is then calculated using the private key p as follows:

Tₖ=Dₚ(E(Tₖ)) (4)

As output, computing system 100 may generate an encrypted trained machine learning model (hereinafter “encrypted model 112”).

Once encrypted model 112 is generated, computing system 100 may load or program encrypted model 112 on an accelerator 114. In some embodiments, accelerator 114 may be representative of a field programmable gate array (FPGA), graphics processing unit, or tensor processing unit. In some embodiments, accelerator 114 may be deployed on an edge device in a computing environment.

In some embodiments, application 106 may further include conversion module 116. Conversion module 116 may be configured to convert the rules of encrypted model 112 to source code for loading or programming on accelerator 114. For example, once training is complete, conversion module 116 may extract or retrieve the decision rules from the root node to each leaf node and may convert the rules into source code (e.g., Verilog source code).

As those skilled in the art understand, any implementation of machine learning on FPGA, such as accelerator 114, includes two steps: the logic development and execution of high-level-synthesis in hardware description language. Digital circuits are those that are based on logic gates, e.g., AND, OR, EXOR, and use Os and is to describe the state of the switch as on or off. Logic synthesis may refer to the technique of automatically producing logic components, such as digital circuits, to execute machine learning algorithm computation. Such process may illustrate how to abstract and describe logic circuits, modify, analyze, and optimize them. In some embodiments, logic synthesis is the process of converting hardware description of source code into a nestlist that may describe the hardware, e.g., the logic gates, flip-flops, wires, and connections. In some embodiments, the logic synthesizer may be configured to conduct resource optimizations to reduce the amount of FPGA hardware. In some embodiments, conversion module 116 may use Verilog as the language for hardware description.

In some embodiments, conversion module 116 may utilize a combinational circuit design for FPGA implementation. Combinational circuits may refer to a grouping of logic gates. The inputs to the log gates may solely determine their outputs. Such circuits may be independent of time. In addition to the absence of notions, such as previous inputs, combinational circuits do not require any clocks. Such circuits may have any number of logic gates and inverters, but no feedback loops. In some embodiments, the function logic of combinational circuits may be represented by a logic diagram and described using Boolean algebra and truth tables.

A decision tree is essentially a Boolean function, which may take a data sample D_{x′s} as input and may return a class or label D_{y′s} as output. In some embodiments, the Boolean function may be optimized using a synthesis tool, thus eliminating the need for a tree structure and the need for memory storage elements. The visualization of decision trees may generate a sequence of nested if-else statements that may terminate into a label as the prediction outcome. For example:

```
always @ (*)
  if ( encrypted_x [ i ] > encrypted_t [ i ] )
    if ( encrypted_x [ k ] > encrypted_t [ k ] )
        if ( encrypted_x [ m ] > encrypted_t [ m ] )
            ..................
            ...............
            label <= encrypted_T1 ;
          else
            label <= encrypted_T2 ;
          ...................
      ....................
end
```

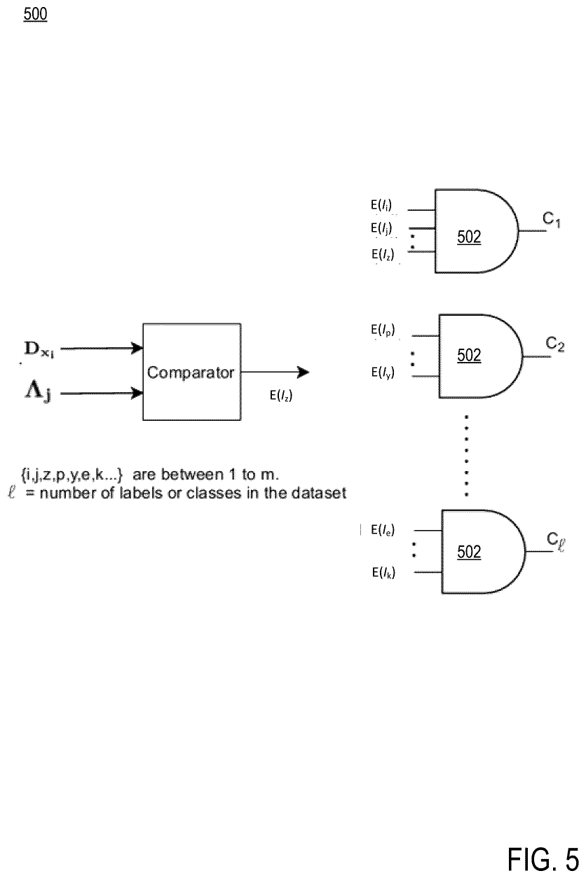

The expression encrypted_x[i] may represent the i^{th} element of array encrypted_x in traditional programming languages. When such a tree is copied into Verilog, the encrypted_x m ay represent the RAM and i may represent the address of that RAM. The expression inside “if” may be evaluated. If it is true, the expressions below it may be executed. If it is not true, the procedural statements corresponding to the “else” keyword may be executed. The * may represent that the code inside “always” block is executed whenever any signal listed within this “always: module undergo changes. In the high-level-synthesis of the above Verilog code, a Boolean function may be generated and then implemented using look-up tables (LUTs) as logic elements with the smallest area footprint. Data samples D_{x′s} to be classified may be provided as inputs to the Boolean function and a class or label as the output. Such a processing of the Boolean function may be shown in FIG. 5, discussed below.

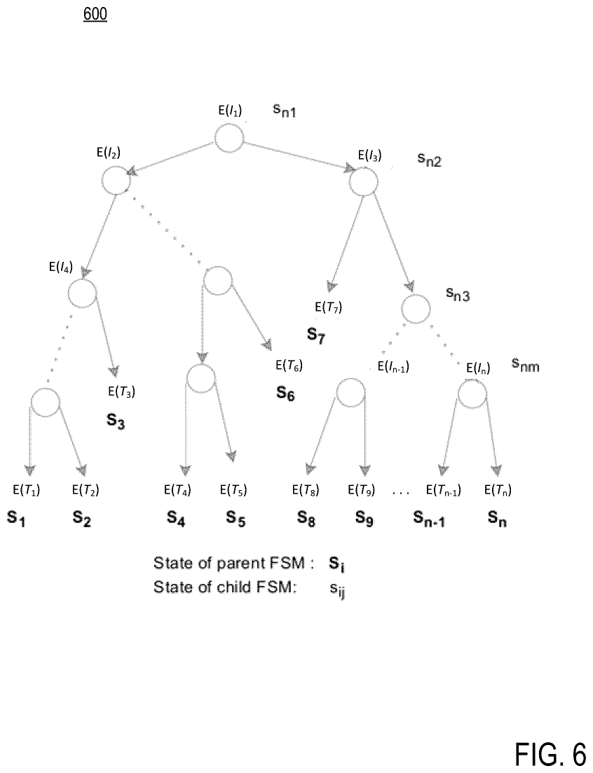

In some embodiments, conversion module 116 may utilize a sequential circuit design for FPGA implementation. A sequential circuit may refer to a grouping of memory units. In some embodiments, flip-flops may be used as the memory components. These circuits may have the ability to “remember” data. As a result, the output of a sequential circuit may be affected by both the current and previous inputs. Furthermore, because flip-flops may be included, the clock input may likewise affect the output of a sequential circuit. Accordingly, they may have the ability to create a complicated logic design. The addition of a memory element with feedback to a combinational circuit may result in a sequential circuit. When dealing with a complex sequentially circuit, using a synchronous methodology rather than an asynchronous approach makes the design challenge much more comprehensible. The same clock signal may activate all storage components in a synchronous circuit. This may result in more control over the system since it is known when the storage units will sample the data. The information contained in the storage components may be considered the system's states. If a system has a finite number of internal states, then the finite state machines (FSM) may be used to construct it. An exemplary circuit design is discussed in more detail below in conjunction with FIG. 6.

Once converted, the source code may be loaded onto accelerator 114 for inference.

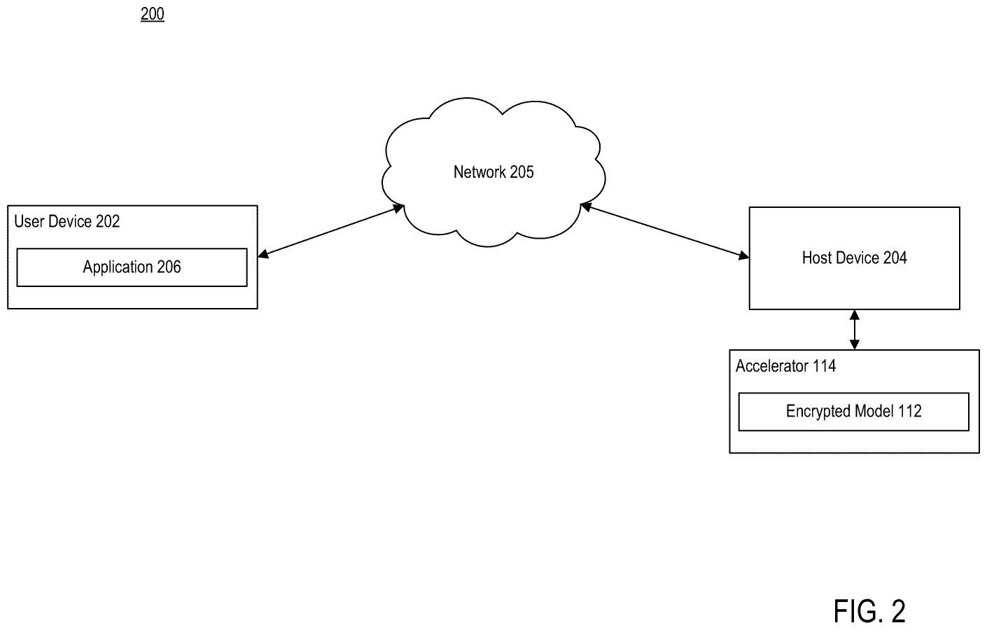

FIG. 2 is a block diagram illustrating a computing environment 200, according to example embodiments. As shown, computing environment 200 may include a user device 202 and a host device 204 communicating via network 205.

Network 205 may be representative of any suitable type, including individual connections via the Internet, such as cellular or Wi-Fi networks. In some embodiments, network 205 may connect terminals, services, and mobile devices using direct connections, such as radio frequency identification (RFID), near-field communication (NFC), Bluetooth™ low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 205 may include any type of computer networking arrangement used to exchange data. For example, network 205 may be representative of the Internet, a private data network, virtual private network using a public network and/or other suitable connection(s) that enables components in computing environment 200 to send and receiving information between the components of computing environment 200.

User device 202 may be operated by a user. In some embodiments, user device 202 may be representative of one or more computing devices, such as, but not limited to, a mobile device, a tablet, a personal computer, a laptop, a desktop computer, or, more generally, any computing device or system having the capabilities described herein.

User device 202 may include application 206. Application 206 may be configured to allow user to interact with host device 204. For example, user device 202 may be configured to execute application 206 to upload a data for analysis by encrypted model 112. In some embodiments, application 206 may provide raw data to host device 204 for analysis. In some embodiments, application 206 may provide encrypted data to host device 204 for analysis. When providing encrypted data as input, user device 202 may receive an encrypted output from host device 204, which may be decrypted locally using application 206.

In some embodiments, host device 204 may be representative of one or more of a server, a cluster of servers, a cloud computing service, or an edge computing device. Host device 204 may include accelerator114. As discussed above, accelerator 114 may include encrypted model 112 executing thereon.

In operation, user device 202 and host device 204 may have agreed upon an encryption algorithm for encrypting trained model 108. In some embodiments, the same encryption algorithm may be used to encrypt data to be analyzed by encrypted model 112. During this process, user device 202 and host device 204 may have agreed upon a specific public-private key combination for the encryption techniques discussed above in conjunction with FIG. 1. For example, following training, the key pair (p, q) may be applied to encrypt the trained decision tree model. At the end of the inference run, user device 202 may receive the encrypted class label from encrypted model 112. User device 202 may decrypt the encrypted class label using the agreed upon private key.

In some embodiments, to transfer data to accelerator 114, host device 204 may use a UART protocol. In a packet of serial transmission, accelerator 114 may receive 8 bits of serial data, one start bit and one stop vit, via UART receive Verilog module. When an 8-bit data packet is received, the receive_complete register may be pushed high for one clock cycle, and the data may be transferred to RAM during this clock cycle. Similarly, the transmitter module may send 8 bits of data with one start bit and one stop bit. The transmit complete register may rise high for one clock cycle to indicate the conclusion of transmission. This register may also indicate that the transmitter module may now accept new data for transmission.

In some embodiments, the inference data samples are serially transferred from host device 204 to accelerator 114 during the inference process. Assume, for example, the inference data samples are Modified National Institute of Standards and Technology database (MNIST) data samples. The MNIST data samples are made up of grayscale pictures with pixel values less than or equal to 255. This causes the threshold of the decision node to be less than or equal to 255 too. Furthermore, the value of the leaf Tᵢ is between 0 and 9 to reflect the label or class of grayscale pictures. With that specification, an 8-bit representation of the decision tree model and inference data is adequate. However, the encrypted value or cipher of nodes, leaves, and inference data may be more than 255. The cipher size is determined by the key value (p, q). The bit width to represent cipher of nodes, leaves, and inference data may be:

$$\\ \begin{matrix}{width}_{E ( Λ )} = ⌊ {log}_{2} max ( {\{ {Λ}_{i} + p + q \}}_{i = 1}^{i = N} ) ⌋ & ( 5 )\end{matrix}$$

$$\\ \begin{matrix}{width}_{E ( L )} = ⌊ {log}_{2} max ( {\{ L + p \times q \}}_{i = 1}^{i = n} ) ⌋ & ( 6 )\end{matrix}$$

$$\\ \begin{matrix}{width}_{E ( {D}_{x} )} = ⌊ {log}_{2} [ max ( {\{ {D}_{{x}_{j}} + p \times q \}}_{j = 1}^{j = Ψ} ] ⌋ & ( 7 )\end{matrix}$$

The notations [N, n, Ψ] may represent the number of nodes and the number of leaves of the decision tree and the size of the data set features, respectively. The operator [.] may represent the rounding operation to the next integer value. The width of the cipher may then be calculated as follows width_{cipher}=max(width_{E(Λ)}, width_{E(L)}, width_{E(D}_{ₓ})).

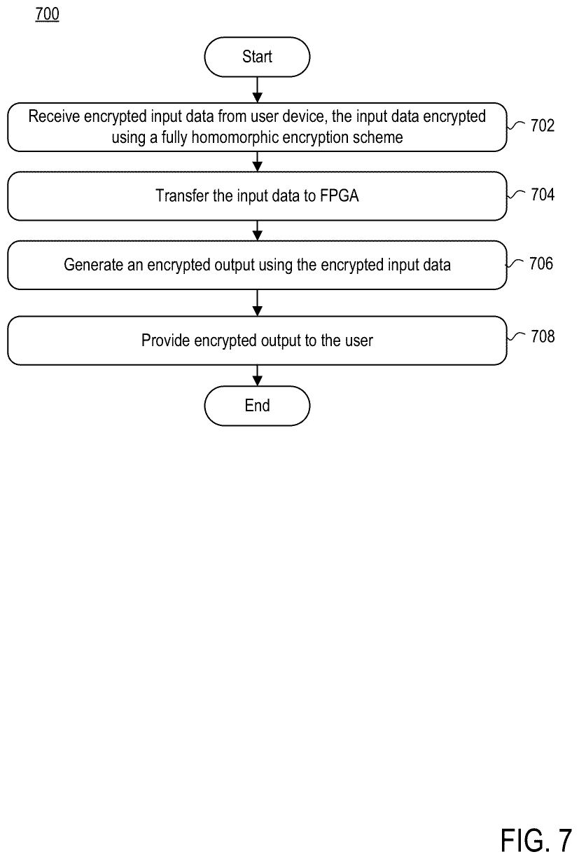

In some embodiments, such as for serial communication, an 8-bit word representation may be employed, for example, the cipher may be subdivided into packets of an 8-bit word. The value of (p, q) may be selected such that the width of ciphertext is less than 24-bit. This makes the three words representation of a cipher. An example is shown below in conjunction with FIG. 7. The receiver module of accelerator 114 may be modified to temporarily store these packets in a register. When all three packets of a ciphertext are received, they may be concatenated and put into RAM. According to such arrangements, the size of RAM that carries the cipher may have a greater width than the RAM that holds encrypted model 112 and inference data in an unencrypted or plain format.

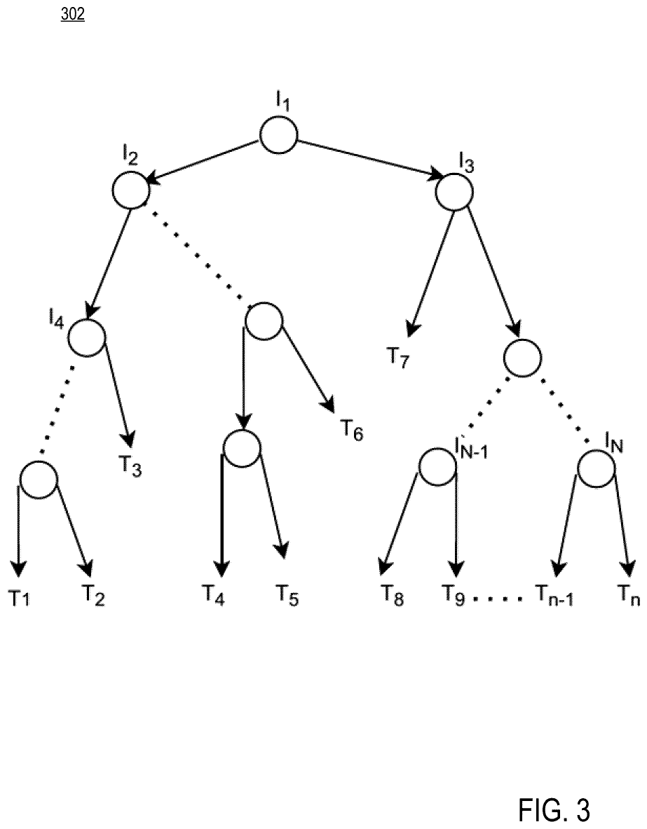

FIG. 3 is a block diagram illustrating an example decision tree model 302, according to example embodiments. In some embodiments, decision tree model 302 may be representative of machine learning model 108 following training but before being encrypted by encryption module 110. As shown, at each node, a comparison inequality between a data set feature [symbol] ₓ_{ₖ} and threshold Λₖ may be performed. If the inequality outcome is true, left side of the node may be evaluated; otherwise, the right side of the node is evaluated. Each internal node is represented as an Iₖ from k=1 . . . N. Each leaf may be represented by Tₖ from k=1 . . . n

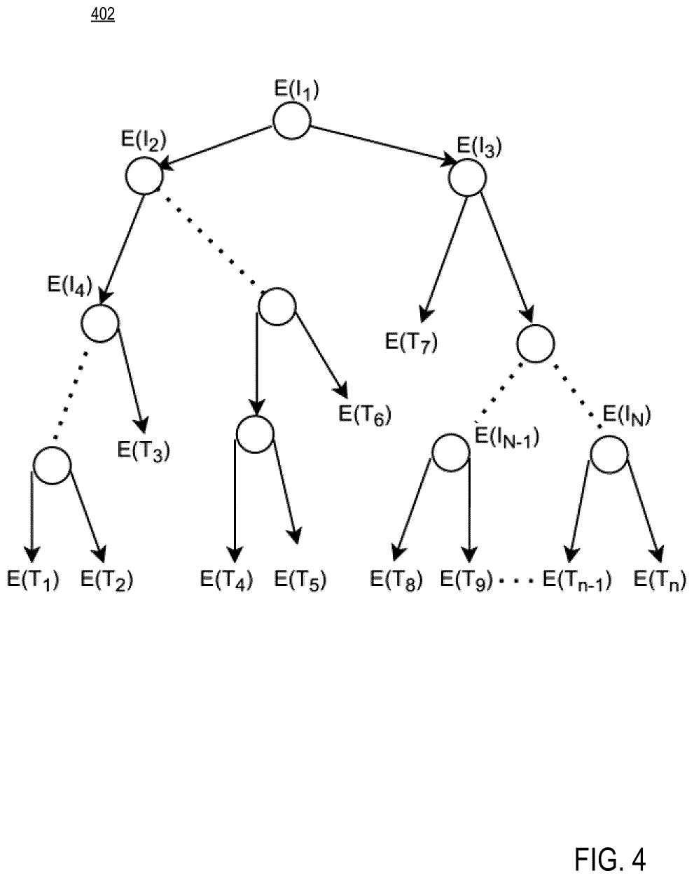

FIG. 4 is a block diagram illustrating an example decision tree model 402, according to example embodiments. In some embodiments, decision tree model 402 may be representative of encrypted model 112. As shown, each node Iₖ and each leaf Tₖ is encrypted using the homomorphic encryption operator E.

FIG. 5 is a block diagram illustrating an example combinational circuit design 500, according to example embodiments. As shown, combinational circuit design 500 may include a plurality of AND gates 502. The number of AND gates 502 may be equal to the number of labels l in the data set. Each AND gate 502 may receive a plurality of encrypted inputs E(Iⱼ) representing the nodes of the encrypted decision tree, where j=1 . . . m. As output, AND gates 502 may generate a class or label of the data set it, i.e., Cᵢ, where i=1 . . . l.

FIG. 6 is a block diagram illustrating an example sequential circuit design 600, according to example embodiments. As shown, sequential circuit design 600 may include parent and child state machines, with the state of a parent state machine being represented by S i and the child state machine being represented by sᵢⱼ. Each node E (Iᵢ) of the decision tree may represent a state of the finite state machine. Each leaf E(Tᵢ) may also represent a state. In some embodiments, the sequential design may be divided into nested state machines referred to as a parent finite state machine and several child finite state machines. Each leaf may be a state of the parent finite state machine denoted by Sᵢ, where 1≤i≤n. The nodes that may fall between the root node E(I₁) and one of the leaf E(Tᵢ) may represent the states in the child finite state machine denoted by sᵢⱼ, where 1≤j≤m. In some embodiments, there could be a different value of m for each path between the root node and leaf node, i.e., the number of states in child finite state machine across different Sᵢ may be different. In each clock cycle, one of the states of the child finite state machines may be evaluated. In this state, one node E(Iᵢ) or inequality relation (e.g., Equation (1)) of a decision tree may be evaluated. This may be attributed to the fact that only a single memory read per clock cycle is feasible in FPGA. In some embodiments, the comparison attributes, including dataset features Dₓ_{ᵢ}_{′s} and threshold values Λ_{j′s} for every node of a decision tree may be stored in a memory. A natural choice for storing this information is within BRAM or distributed RAM. In some embodiments, the inference data samples may also be stored in RAM.

In some embodiments, inference data samples are read from the memory and fed into the first state S₁ of parent finite state machine. Then the states s₁₁, s₁₂, s₁ₘ within the child finite state machine corresponding to the parent finite state machine S₁ may be evaluated. In state S₁, if all the inequality of the states s₁₁, s₁₂, s₁ₘ are true, then the class/label E (T₁) may be returned as an inferential result and “next state” register may be reset to accept new inference data sample. If, however, the inequality of any state starting from s₁₁, s₁₂, s₁ₘ is false, then the “state” register may be incremented, and the state transition proceeds to S₂. This process may continue to the following clock cycles until it attains the state where all the inequality child finite state machines s₁₁, s₁₂, s₁ₘ are true. When all the inference data samples are processed, the state transition may stop, the state register may be reset, and all other evaluation may cease.

FIG. 7 is a flow diagram illustrating a method of evaluating a data input using an encrypted machine learning model, according to example embodiments. Method 700 may begin at step 702.

At step 702, host device 204 may receive input data from user device 202. In some embodiments, input data may be encrypted prior to transmission from user device 202 to host device 204. For example, user device 202 may encrypt the input data using a previously agreed upon encryption schema with host device 204. For example, user device 202 may encrypt the input data using an agreed upon public/private key pair (p, q).

At step 704, host device 204 may transfer the input data to accelerator 114, connected thereto, for analysis. For example, as previously discussed, accelerator 114 may include an encrypted trained machine learning model. In some embodiments, the machine learning model may be representative of a decision tree model.

At step 706, host device 204 may generate an encrypted output using the encrypted input data. For example, host device 204 may evaluate the encrypted input data using the encrypted trained machine learning model loaded on accelerator 114. In this manner, the encrypted trained machine learning model may evaluate the encrypted input data from the root node of the decision tree to a leaf node.

At step 708, host device 204 may provide encrypted output to the user. For example, as previously discussed, the encrypted input data may result in an encrypted output generated by the encrypted trained machine learning model. User device 202 may be able to decrypt the encrypted output using the agreed upon public/private key pair (p, q).

The foregoing discussion focused on the use of fully homomorphic encryption to encrypt machine learning models and/or data for inference. The following discussion focuses on using order-preserving encryption to perform a similar process. By using order-preserving encryption, computation may be performed on the encrypted data. As a result, data can remain hidden while being processed during inference operations. Accordingly, the following discussion provides an order-preserving encryption mechanism for confidential inference on a supervised decision-tree learning model. In some embodiments, the following discussion may provide a sequential circuit design for the encrypted decision tree model, which may be evaluated on an FPGA board. In some embodiments, the present system may calculate the inference throughput of the encrypted decision tree.

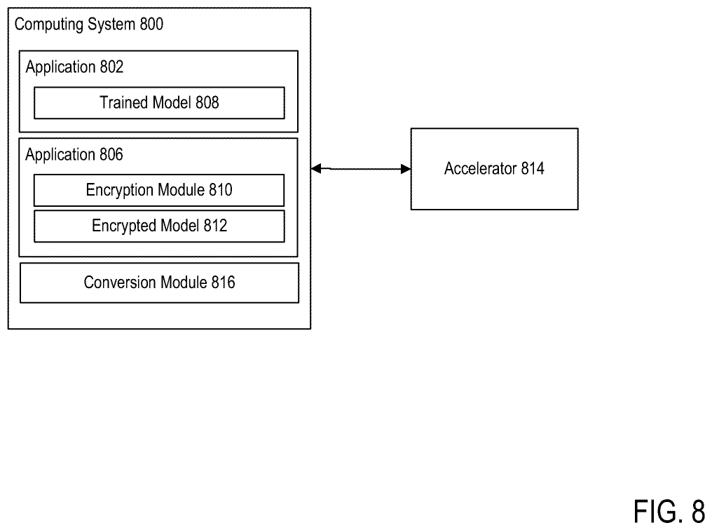

FIG. 8 is a block diagram illustrating computing system 800, according to example embodiments. As shown, computing system 800 may include an application 802. Application 802 may allow a user of computing system 800 to train a machine learning model for a task. In some embodiments, machine learning model may be representative of a decision tree based model. As shown, the trained machine learning model may be represented a trained model 808. Components of computing system 800 may be substantively similar to components of computing system 100 discussed above in conjunction with FIGS. 1-8.

As shown, computing system 800 may further include application 806. Application 806 may be configured to encrypt trained machine learning model 808 using encryption module 810. Encryption module 810 may be configured to convert trained machine learning model 808 into a secure representation that can be used for inference without disclosing any information about the learned model parameters (e.g., the feature and the threshold involved in a given decision rule). The secure representation may then receive inference data in encrypted form and deliver the correct inference result also in encrypted form.

In some embodiments, encryption module 810 may be configured to use order-preserving encryption to encrypt trained machine learning model 808. Generally, order-preserving encryption is an encryption scheme whose encryption function preserves the numerical order of the plaintexts.

The order-preserving function f from a domain [symbol] ₚ={0, 1, 2, . . . , Rₚ} to a domain [symbol] ₚ={0, 1, 2, . . . , R_{c}} , where R_{c}>Rₚ may be uniquely represented by a combination of Rₚ out of R_{c} ordered items, were Rₚ and R_{c} are the ranges of plaintexts and ciphertexts, respectively. In some embodiments, the key of the encryption function may be composed of two aspects: (1) the probability distribution of ciphertexts over [symbol] _{c}; and (2) the unique mapping j=f(i), i ∈ [symbol] ₚ, j ∈ [symbol] R_{c} that may produce to unique combination of elements from the plaintext and ciphertext domains.

From any two pairs of plaintexts and ciphertexts (mₐ, cₐ) and (m_{b}, c_{b}), such that m_{b}>mₐ, the inequality c_{b}>cₐ must be satisfied for the encryption function f to be order-preserving. In some embodiments, the order-preserving scheme may be based on the relationship between the random-order preservation function and the hypergeometric probability distribution. The scheme may be a symmetric scheme that includes three algorithms (K_{gen}, Enc, Dec).

K_{gen} en may be representative of a key generation algorithm that returns a secret key [symbol] .

Enc may be representative of an encryption algorithm that takes the secret key, the [symbol] ₚ domain, the [symbol] _{c} domain, and a plaintext message mᵢ, and may return a ciphertext cᵢ, such that mᵢ>mᵢ₋₁⇒cᵢ>cᵢ₋₁, ∀i.

Dec may be representative of a decryption algorithm that may take [symbol] , [symbol] ₚ, [symbol] _{c}, and ciphertext cᵢ to return the corresponding plaintext message mᵢ.

Encryption module 810 may employ the foregoing order-preserving encryption scheme to convert trained machine learning model 808 into a secure representative that may be used for inference without disclosing any information about the parameters of trained machine learning model.

To encrypt the decision tree, encryption module 810 may encrypt the computations at the internal nodes. For example, after training, each internal node makes a “greater-than” or “less-than” comparison between the assigned threshold and the value of the data feature as shown in Equation (1).

Let E [symbol] be the order-preserving encryption operator with secret key [symbol] , then the encrypted versions of the above inequalities are written as:

E [symbol] ( [symbol] ₓ_{ₖ})<E [symbol] (Λₖ) or E [symbol] ( [symbol] ₓ_{ₖ})≥E [symbol] (Λₖ) (8)

Note that in Eq. (8), the order (<, ≥) of [symbol] ₓ_{ₖ} with respect to Λₖ is preserved as in Eq. (1), i.e., [symbol] ₓ_{ₖ}−Λₖ=D [symbol] (E [symbol] ( [symbol] ₓ_{ₖ})−E [symbol] (Λₖ)), where D [symbol] is the decryption operator using the secret key [symbol] .

As those skilled in the art understand, the encrypted model may deliver the correct inference result in encrypted form. As a result, the leaf node labels Tk may also be encrypted −E [symbol] (Tₖ). The inferred class label is then calculated using the key [symbol] as follows:

Tₖ=D [symbol] (E [symbol] (Tₖ)) (9)

As output, computing system 800 may generate an encrypted trained machine learning model (hereinafter “encrypted model 812”).

Once encrypted model 812 is generated, computing system 800 may load or program encrypted model 812 on an accelerator 814. In some embodiments, accelerator 814 may be representative of a field programmable gate array (FPGA), graphics processing unit, or tensor processing unit. In some embodiments, accelerator 814 may be deployed on an edge device in a computing environment.

In some embodiments, application 806 may further include conversion module 816. Conversion module 816 may be configured to convert the rules of encrypted model 812 to source code for loading or programming on accelerator 814. For example, once training is complete, conversion module 816 may extract or retrieve the decision rules from the root node to each leaf node and may convert the rules into source code (e.g., Verilog source code). Conversion module 816 may perform similar processes as discussed above in conjunction with FIG. 1. For example, conversion module 816 may utilize a sequential circuit design for accelerator implementation.

Once converted, the source code may be loaded onto accelerator 814 for inference.

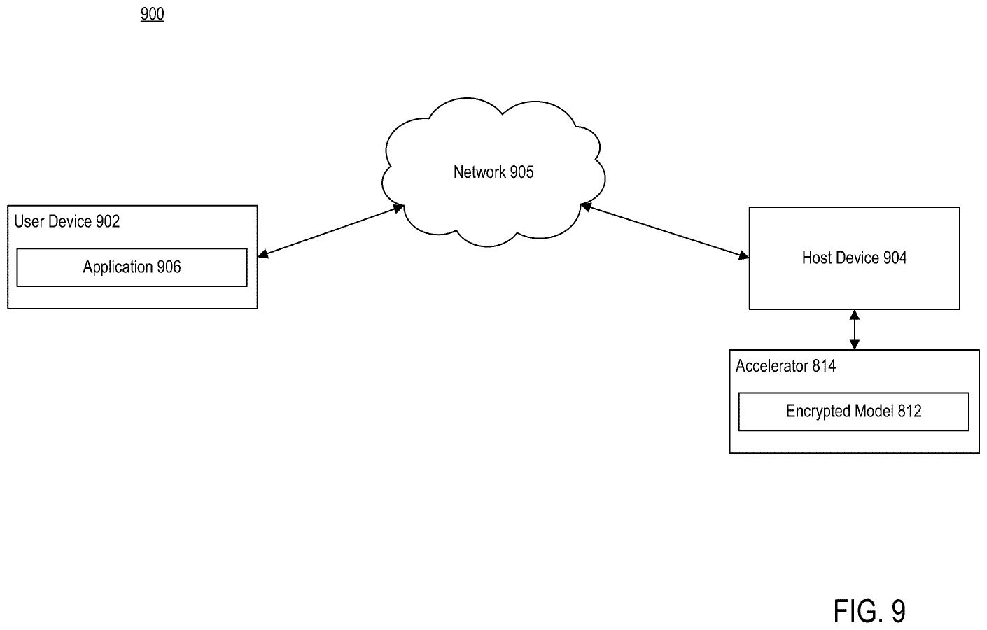

FIG. 9 is a block diagram illustrating a computing environment 900, according to example embodiments. As shown, computing environment 900 may include a user device 902 and a host device 904 communicating via network 905.

Network 905 may be representative of any suitable type, including individual connections via the Internet, such as cellular or Wi-Fi networks. In some embodiments, network 905 may connect terminals, services, and mobile devices using direct connections, such as radio frequency identification (RFID), near-field communication (NFC), Bluetooth™ low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 905 may include any type of computer networking arrangement used to exchange data. For example, network 905 may be representative of the Internet, a private data network, virtual private network using a public network and/or other suitable connection(s) that enables components in computing environment 900 to send and receiving information between the components of computing environment 900.

User device 902 may be operated by a user. In some embodiments, user device 902 may be representative of one or more computing devices, such as, but not limited to, a mobile device, a tablet, a personal computer, a laptop, a desktop computer, or, more generally, any computing device or system having the capabilities described herein.

User device 902 may include application 906. Application 906 may be configured to allow user to interact with host device 904. For example, user device 902 may be configured to execute application 906 to upload a data for analysis by encrypted model 812. In some embodiments, application 906 may provide raw data to host device 904 for analysis. In some embodiments, application 906 may provide encrypted data to host device 904 for analysis. When providing encrypted data as input, user device 902 may receive an encrypted output from host device 904, which may be decrypted locally using application 906.

Host device 904 may include accelerator 814. As discussed above, accelerator 814 may include encrypted model 812 executing thereon.

In operation, user device 902 and host device 904 may have agreed upon an encryption algorithm for encrypting trained machine learning model 808 to generate encrypted model 812. In some embodiments, the same encryption algorithm may be used to encrypt data to be analyzed by encrypted model 812. During this process, user device 902 and host device 904 may have agreed upon a specific secret key for the encryption techniques discussed above in conjunction with FIG. 8. At the end of the inference run, user device 902 may receive the encrypted class label from encrypted model 812. User device 902 may decrypt the encrypted class label using the decryption algorithm Dec.

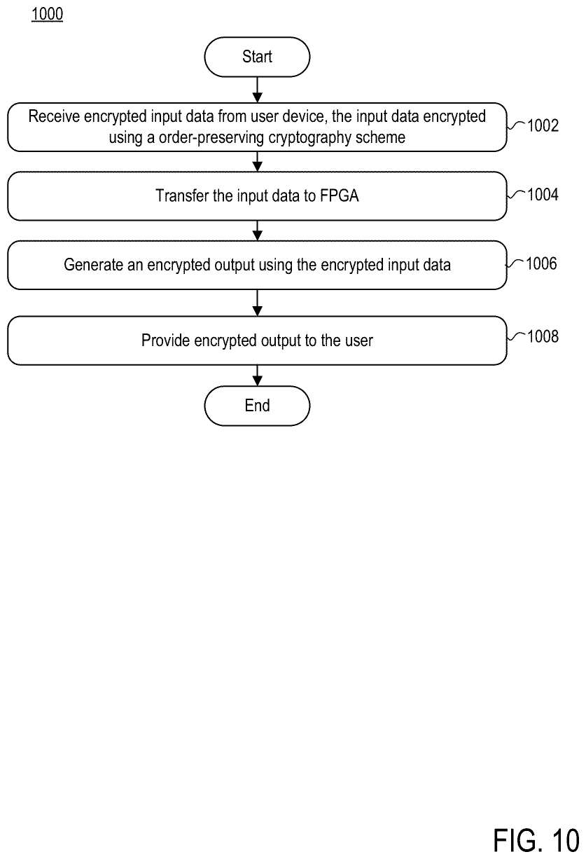

FIG. 10 is a flow diagram illustrating a method 1000 of evaluating a data input using an encrypted machine learning model, according to example embodiments. Method 1000 may begin at step 702.

At step 1002, host device 904 may receive input data from user device 902. In some embodiments, input data may be encrypted prior to transmission from user device 902 to host device 904. For example, user device 902 may encrypt the input data using a previously agreed upon encryption schema with host device 904, such as an order preserving cryptography schema discussed above. For example, user device 902 may encrypt the input data using secret key [symbol] .

At step 1004, host device 904 may transfer the input data to accelerator 814, connected thereto, for analysis. For example, as previously discussed, accelerator 814 may include an encrypted trained machine learning model. In some embodiments, the machine learning model may be representative of a decision tree model.

At step 1006, host device 904 may generate an encrypted output using the encrypted input data. For example, host device 904 may evaluate the encrypted input data using the encrypted trained machine learning model loaded on accelerator 814. In this manner, the encrypted trained machine learning model may evaluate the encrypted input data from the root node of the decision tree to a leaf node.

At step 1008, host device 904 may provide encrypted output to the user. For example, as previously discussed, the encrypted input data may result in an encrypted output generated by the encrypted trained machine learning model. User device 902 may be able to decrypt the encrypted output using secret key [symbol] .

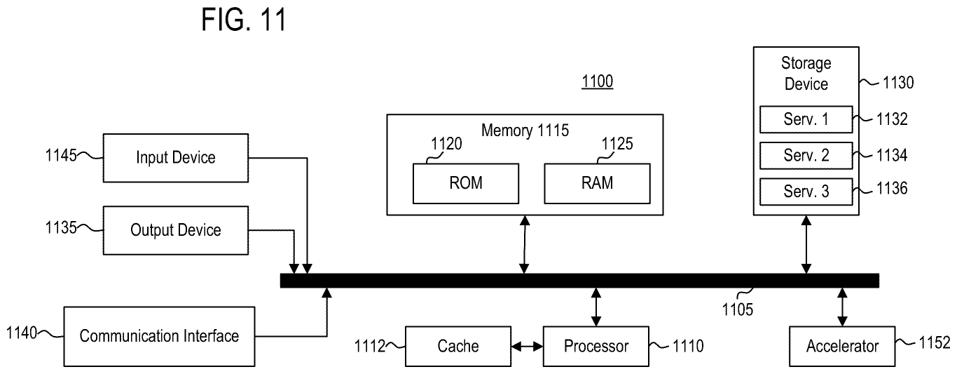

FIG. 11 illustrates an example system bus architecture of computing system 1100, according to example embodiments. System 1100 may be representative of a computing system for generating and encrypting a machine learning model, such as a decision tree model, residing on chips such as an accelerator. One or more components of system 1100 may be in electrical communication with each other using a bus 1105. System 1100 may include a processing unit (CPU or processor) 1110 and a system bus 1105 that couples various system components including the system memory 1115, such as read only memory (ROM) 1120 and random-access memory (RAM) 1125, to processor 1110. System 1100 may include a cache of high-speed memory connected directly with, in close proximity to, or integrated as part of processor 1110. System 1100 may copy data from memory 1115 and/or storage device 1130 to cache 1112 for quick access by processor 1110. In this way, cache 1112 may provide a performance boost that avoids processor 1110 delays while waiting for data. These and other modules may control or be configured to control processor 1110 to perform various actions. Other system memory 1115 may be available for use as well. Memory 1115 may include multiple different types of memory with different performance characteristics. Processor 1110 may include any general-purpose processor and a hardware module or software module, such as service 1 1132, service 2 1134, and service 3 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction with the computing system 1100, an input device 1145 may represent any number of input mechanisms, such as a microphone for speech, a touch-sensitive screen for gesture or graphical input, keyboard, mouse, motion input, speech and so forth. An output device 1135 may also be one or more of a number of output mechanisms known to those of skill in the art. In some instances, multimodal systems may enable a user to provide multiple types of input to communicate with computing system 1100. Communications interface 1140 may generally govern and manage the user input and system output. There is no restriction on operating on any particular hardware arrangement and therefore the basic features here may easily be substituted for improved hardware or firmware arrangements as they are developed. Storage device 1130 may be a non-volatile memory and may be a hard disk or other types of non-transitory computer readable media which may store data that are accessible by a computer, such as magnetic cassettes, flash memory cards, solid state memory devices, digital versatile disks, cartridges, random access memories (RAMs) 1125, read only memory (ROM) 1120, and hybrids thereof. Storage device 1130 may include services 1132, 1134, and 1136 for controlling the processor 1110. Other hardware or software modules are contemplated. Storage device 1130 may be connected to system bus 1105. In one aspect, a hardware module that performs a particular function may include the software component stored in a computer-readable medium in connection with the necessary hardware components, such as processor 1110, bus 1105, output device 1135, and so forth, to carry out the function.

Computing system 1100 may be used to encrypt a machine learning model using a fully homomorphic encryption algorithm or an order-preserving cryptography algorithm. A programmable chip (e.g., accelerator) 1152 may be coupled to system 1100 via a dedicated connection. Once programmed, the accelerator may be deployed in the field, such as on a host device.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method, comprising:
initiating, by a server system comprising a host device, an encrypted decision tree model executing on an accelerator coupled with the host device, the encrypted decision tree model encrypted using an agreed upon encryption schema between the host device and a user device accessing the encrypted decision tree model;
receiving, by the host device, an input, from the user device, to be evaluated using the encrypted decision tree model, the input encrypted using the agreed upon encryption schema;
evaluating, by the host device using the encrypted decision tree model, the input from the user device without decrypting the input;
generating, by the accelerator using the encrypted decision tree model, an encrypted output based on the evaluating; and
providing, by the accelerator device, the encrypted output to the user device.

2. The method of claim 1, wherein the host device is one of a server, a cluster of servers, a cloud computing service, or an edge computing device, and wherein the accelerator is one of a field programmable gate array, graphics processing unit, or tensor processing unit.

3. The method of claim 1, wherein the agreed upon encryption schema is a fully homomorphic encryption algorithm.

4. The method of claim 3, wherein the encrypted decision tree model and the input are encrypted using the same public/private key pair.

5. The method of claim 1, wherein the agreed upon encryption schema is an order-preserving cryptography schema.

6. The method of claim 5, wherein the encrypted decision tree model and the input are encrypted using the same secret key.

7. The method of claim 1, further comprising:
generating, by the server system, the encrypted decision tree model by encrypting computations performed at each internal node of the encrypted decision tree model;
extracting, by the server system, decision rules performed from a root node of the encrypted decision tree model to each leaf node; and
converting, by the server system, the decision rules into source code for upload to the accelerator.

8. A non-transitory computer readable medium comprising one or more sequences of instructions, which, when executed by one or more processors, causes a server system to perform operations comprising:
initiating, by the server system comprising a host device, an encrypted decision tree model executing on an accelerator coupled with the host device, the encrypted decision tree model encrypted using an agreed upon encryption schema between the host device and a user device accessing the encrypted decision tree model;
receiving, by the host, an input, from the user device, to be evaluated using the encrypted decision tree model, the input encrypted using the agreed upon encryption schema;
evaluating, by the host device using the encrypted decision tree model, the input from the user device without decrypting the input;
generating, by the host device using the encrypted decision tree model, an encrypted output based on the evaluating; and
providing, by the host device, the encrypted output to the user device.

9. The non-transitory computer readable medium of claim 8, wherein the host device is one of a server, a cluster of servers, a cloud computing service, or an edge computing device, and wherein the accelerator is one of a field programmable gate array, graphics processing unit, or tensor processing unit.

10. The non-transitory computer readable medium of claim 8, wherein the agreed upon encryption schema is a fully homomorphic encryption algorithm.

11. The non-transitory computer readable medium of claim 10, wherein the encrypted decision tree model and the input are encrypted using the same public/private key pair.

12. The non-transitory computer readable medium of claim 8, wherein the agreed upon encryption schema is an order-preserving cryptography schema.

13. The non-transitory computer readable medium of claim 12, wherein the encrypted decision tree model and the input are encrypted using the same secret key.

14. The non-transitory computer readable medium of claim 8, further comprising:
generating, by the server system, the encrypted decision tree model by encrypting computations performed at each internal node of the encrypted decision tree model;
extracting, by the server system, decision rules performed from a root node of the encrypted decision tree model to each leaf node; and
converting, by the server system, the decision rules into source code for upload to the accelerator.

15. A system, comprising:
a processor in communication with an accelerator comprising an encrypted decision tree model executing thereon; and
a memory having programming instruction stored thereon, which, when executed by the processor, causes the system to perform operations comprising:
initiating the encrypted decision tree model executing on the accelerator, the encrypted decision tree model encrypted using an agreed upon encryption schema between the system and a user device accessing the encrypted decision tree model;
receiving an input, from the user device, to be evaluated using the encrypted decision tree model, the input encrypted using the agreed upon encryption schema;
evaluating, using the encrypted decision tree model, the input from the user device without decrypting the input;
generating, using the encrypted decision tree model, an encrypted output based on the evaluating; and
providing the encrypted output to the user device.

16. The system of claim 15, wherein the agreed upon encryption schema is a fully homomorphic encryption algorithm.

17. The system of claim 16, wherein the encrypted decision tree model and the input are encrypted using the same public/private key pair.

18. The system of claim 15, wherein the agreed upon encryption schema is an order-preserving cryptography schema.

19. The system of claim 18, wherein the encrypted decision tree model and the input are encrypted using the same secret key.

20. The system of claim 15, wherein the operations further comprise:
generating the encrypted decision tree model by encrypting computations performed at each internal node of the encrypted decision tree model;
extracting decision rules performed from a root node of the encrypted decision tree model to each leaf node; and
converting the decision rules into source code for upload to the accelerator.
